(19) United States
(12) Patent Application Publication
(10) Pub. No.: US 2026/0303627 A1
(43) Pub. Date: Oct. 1, 2026

(54) SECURITY ACTION BASED ON AGENTIC AI SYSTEM-INITIATED FRAMEWORK-BASED THREAT MAPPINGS

(71) Applicant: Microsoft Technology Licensing, LLC, Redmond, WA (US)

(72) Inventors: Jonatan ZUKERMAN, Matan (IL); Michal SHECHTER NACHMANY, Hod Hasharon (IL); Miriam WEISSLER, Kiryat Ye'arim (IL); Yaniv MELAMED, Jerusalem (IL)

(21) Appl. No.: 19/093,187

(22) Filed: Mar. 27, 2025

(51) Int. Cl. H04L 9/40

(52) U.S. Cl. CPC H04L 63/1425; H04L 63/1441

(57) ABSTRACT

A computing system for artificial intelligence-automated review of agentic flows includes processing circuitry configured to implement an agentic flow in an artificial intelligence agent. The agent includes an assistant, a user proxy, and a critic. The user proxy receives information related to an event and instructions to process the event. In a first conversation between the assistant and the user proxy, the user proxy receives a recommendation for a tool and returns a tool response to the assistant after executing the tool. The assistant generates a tool response report and sends the tool response report to the user proxy. In a second conversation between the user proxy and the critic, the user proxy sends the tool response report to the critic. The critic reviews the tool response report for errors and returns any detected errors to the user proxy. The user proxy relays the detected errors to the assistant.

### BACKGROUND

Agentic systems leverage artificial intelligence (AI) models, or agents, to perform complex tasks and make independent decisions without the need for sustained human supervision. In one example, an agentic flow within an agent executing a task involves an iterative turn-based conversation between an assistant and a user proxy, both of which may be implemented utilizing large language model (LLM) instances. The assistant recommends tools, and the user proxy executes the tools until a solution is reached. However, if the assistant makes an incorrect conclusion or generates a hallucination at any point in the agentic flow, subsequent tool calls and responses may be erroneous. Due to the possibility for such error, human review and validation of agent outputs is often performed to ensure the accuracy of agentic systems, which can be time consuming, costly, and difficult to scale.

### SUMMARY

To address the issues discussed herein, computing systems and methods for artificial intelligence-automated review of agentic flows are provided. According to one aspect, a computing system includes processing circuitry configured to execute instructions using portions of associated memory to implement an agentic flow in an automated artificial intelligence (AI) agent. The agent comprises an assistant, a user proxy, and a critic. The user proxy is configured to receive an event prompt, which includes information related to an event and instructions to investigate the event. In a first conversation between the assistant and the user proxy, the user proxy receives a recommendation for a tool from the assistant and returns a tool response to the assistant after executing the recommended tool, and the assistant generates a tool response report and sends the tool response report to the user proxy. In a second conversation between the user proxy and the critic, the user proxy sends the tool response report to the critic, and the critic reviews the tool response report for errors and, in the case that one or more errors is detected by the critic returns the one or more detected errors to the user proxy. The user proxy relays the one or more detected errors to the assistant.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of a computing system for artificial intelligence-automated review of agentic flows, according to one embodiment of the present disclosure.

FIG. 2A shows a tool call and analysis loop in accordance with the computing system of FIG. 1.

FIG. 2B shows an agent call and analysis loop in accordance with the computing system of FIG. 1.

FIG. 3 shows a schematic view of a multi-agent orchestration of agents in accordance with the computing system of FIG. 1.

FIG. 4 shows a flowchart of a method according to an example implementation of the present disclosure.

FIG. 5 shows an example computing system according to one implementation of the present disclosure.

### DETAILED DESCRIPTION

In view of the issues discussed above, a computing system for artificial intelligence-automated review of agentic flows is disclosed herein. The computing system addresses the issues discussed above by implementing a critic in an agent to autonomously review the agentic flow. The user proxy forwards the tool response report to the critic after the tool has been suggested and executed, and the critic adjudicates the report, identifies any errors, and recommends repairs. The system enables correction of intermediate incorrect conclusions during the agentic flow, thereby increasing accuracy and efficiency of AI-automated tasks and multi-agent agentic workflows.

In the context of cybersecurity, a Security Operations Center (SOC) can utilize a multi-agent agentic workflow to implement a fully automated security alert investigation system for triaging and reporting events, with no human in the loop. The investigation space can be divided across several agents that focus on different aspects of the security investigation, each agent including a critic to review the respective agentic flow.

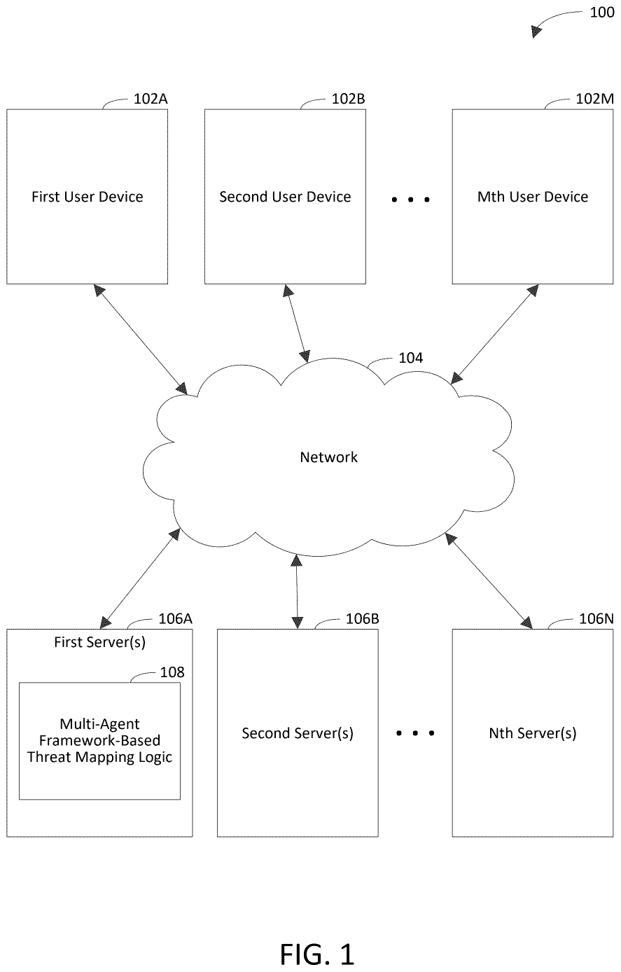

Referring initially to FIG. 1, the computing system 10 includes at least one computing device. The computing system 10 is illustrated as having a first computing device 12 including processing circuitry 14 and memory 16, and a second computing device 18 including processing circuitry 20 and memory 22, the second computing device 18 being in communication with the first computing device 12 via a network. The illustrated implementation is exemplary in nature, and other configurations are possible. In the description below, the first computing device will be described as a server 12 and the second computing device will be described as a client computing device 18, and respective functions carried out at each device will be described. It will be appreciated that in other configurations, the computing system 10 may include a single computing device that carries out the salient functions of both the server 12 and client computing device 18, and that the first computing device could be a computing device other than server. In other alternative configurations, functions described as being carried out at the server 12 may alternatively be carried out at the client computing device 18 and vice versa.

Continuing with FIG. 1, the processing circuitry 14 is configured to execute instructions 24 using portions of associated memory 16 to implement an agentic flow in an automated AI agent. In the embodiments disclosed herein, the agentic flow will be described in the context of a security operations center (SOC) investigation program 26 included in an SOC. However, it will be appreciated that the agentic flow may be implemented in another suitable program that utilizes AI agents to autonomously process information and automate tasks. For example, in AI-automated systems not related to cybersecurity and alert event investigations, the agentic flow may be implemented in response to an event, such as a trigger for information processing, rather than an alert event, and include instructions to implement an agentic flow to determine one or more tools to address the event.

Organizations often employ SOCs to monitor their information systems and data to detect and respond to security threats. SOC functions typically include the identification, prevention, detection, and investigation of security threats, responding to identified threats, and recovery of system after a cybersecurity event. In the embodiments described herein, the server 12 the handles detection and investigation phases of the overall SOC workflow, and may be implemented as security information and event management (SIEM) server, for example.

Upstream of the SOC investigation program 26, event detection agents 28 analyze incoming data streams for potential cybersecurity events, such as malware attacks and data breaches. Cybersecurity events may be detected via SIEM correlation rules, user and entity behavior analytics (UEBA), malware signatures, and attack patterns. As illustrated in FIG. 1, such events may occur at the client computing device 18 and include, for example, unusual login attempts to a secure application 30 or corrupt email attachments in an email application 32, which may be visible to a user via interfaces shown on a display 34 of the client computing device 18, as well as modifications to a secure data file 36, unauthorized software installations 38, and unexpected configuration changes 40, which may be unknown to the user.

The event detection agents 28 generate alerts for detected potential alert events, which are then passed to alert triage agents 42. The alert triage agents 42 are configured to review the alert events and prioritize them based on their severity and potential impact. Using machine learning (ML) and large language models (LLMs), the alert events are mapped to a comprehensive framework (e.g., ATT&CK) that defines tactics, techniques, and procedures (TTPs) used in cyberattacks and intrusions. Risk scores are assigned based on threat intelligence (TI) correlation, identification of same/similar indicators that were seen in past alert events, and detection of anomalous behavior. False alerts are dismissed, low-risk alerts may be flagged or logged for future events, and high-risk alerts are escalated for investigation to determine if the alert is a cybersecurity attack. An alert message 44, including alert information and a corresponding alert identification (ID), is subsequently transmitted to an alert investigation agent 46 included in the SOC investigation program 26, which is configured to implement an agentic flow to determine one or more tools to investigate the alert event.

The alert investigation agent 46 includes an assistant 48, a user proxy 50, and a critic 52. In some embodiments, the assistant 48, the user proxy 50, and the critic 52 are implemented utilizing large language models LLMs (e.g., the assistant 48, the user proxy 50, and the critic 52 can be programs that call one or more LLMs executed on a server and receive a response). The LLMs can be generative pre-trained transformer models, such as Chat-GPT 4o, LLaMA, etc. In some examples, the models can be multi-modal models configured to accept text, images, and/or audio as forms of input and configured to generate text, images, and/or audio as output. It will be appreciated that the assistant 48, the user proxy 50, and the critic 52 are implemented utilizing one or more small language models as well. Models such as Deepseek and o3 mini can also be used. Additionally or alternatively, one or more of the assistant 48, the user proxy 50, and the critic 52 may be alternatively implemented using a natural language processing (NLP) model, for example. The alert message 44 is received by the user proxy 50, which may be pre-configured with a system prompt, such as an alert prompt 54. Receiving the alert message 44 may trigger the alert prompt 54 and instruct the user proxy 50 to investigate the alert event.

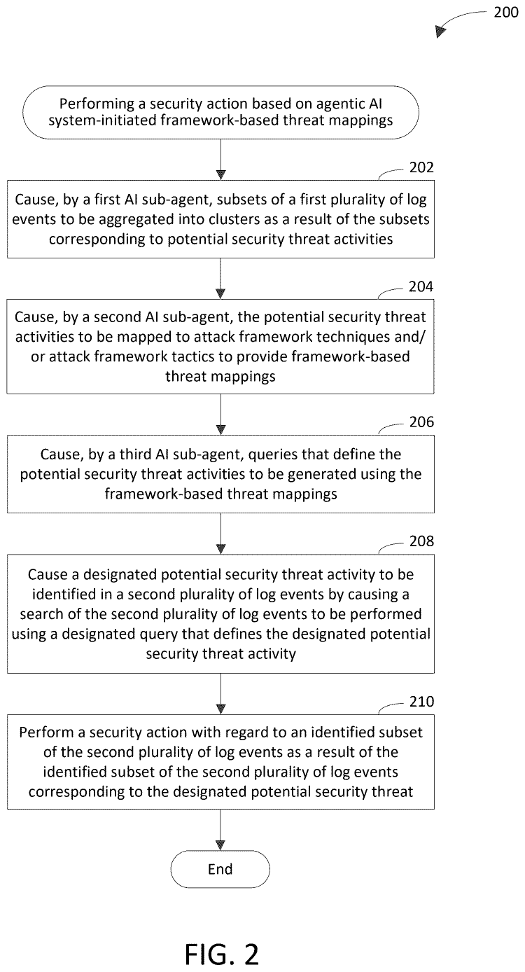

FIG. 2A shows a schematic view of a tool call and analysis loop 56, which may be implemented as an agentic flow within the agent 46. As illustrated at (1), in response to the alert prompt 54, the user proxy 50 may send an initial message to the assistant 48 to thereby implement the agentic flow to determine one or more tools 58 to investigate the alert event. In addition to the alert prompt 54, the user proxy 50 may also be pre-configured with tool definitions.

The assistant 48 is pre-configured with an assistant prompt 60, which may be a system prompt with which the assistant 52 is bootstrapped, as well as tool definitions. The assistant prompt 60 may state, for example, “You are an SOC (Security Operations Center) analyst that investigating alert events. You receive an ID that represents an alert event. Conduct a thorough investigation into the provided alert event.” The assistant prompt 60 may include a command to follow a series of ordered investigation steps to classify the event as malicious, benign, inconclusive, error, or hallucination, for example, using a set of defined classification rules provided in the assistant prompt 60 or otherwise retrievable by the assistant 48.

In a first conversation 62 (i.e., agentic tool flow, indicated by the dashed line) between the assistant 48 and the user proxy 50, the user proxy 50 receives a recommendation for a tool 58 from the assistant 48, as indicated at (2). The tool may include investigation instructions 64 (shown in FIG. 1), such as specified investigation steps, to retrieve details to inspect certain aspects of the alert event. The user proxy 50 executes the recommended tool 58 (3), receives a tool response (4), and returns the tool response to the assistant 48 (5). The assistant 48 generates a tool response report and sends the tool response report to the user proxy 50 (6).

In a second conversation 66 (i.e., agentic critic flow, indicated by the dash-dot line) between the user proxy 50 and the critic 52, the user proxy 50 sends the tool response report to the critic 52 (7). In some embodiments, the critic 52 is invoked by the user proxy 50. Additionally, the critic 52 may be embedded in the user proxy 50. As such, the critic 52 may act as a sort of internal conversation

The critic 52 is configured to review the tool response report for errors, such as the assistant 48 skipping an investigation step or recommending an incorrect tool in response to an investigation finding. The critic 52 is provided with critic prompt 68, which may state, for example, “You are an SOC (Security Operations Center) critic that specializes in reviewing tool response reports. You determine if tool response reports contain errors.” The critic prompt 68 may include a command to review the tool response report in view of the ordered investigation steps and classification rules by which the assistant 48 investigated the alert event.

Any errors in the tool response report that are detected by the critic 52 are returned to the user proxy 50 in an error report (8). The critic 52 may be further configured to suggest solutions to the user proxy 50 to repair the detected errors. The user proxy 50 is configured to relay the error report, including the detected errors and suggested solutions, to the assistant 48 (9). However, the user proxy 50 uses the findings of the critic 52 to respond to the assistant 48 as if it created the error report itself to rectify the flaw in the tool response report. As such, the assistant 48 is naïve to the second conversation 66 between the user proxy 50 and the critic 52. It will be appreciated that, as used herein, the term “naïve to” means that the assistant 48 does not have access to data for the second conversation 66 between the user proxy 50 and the critic 52, and thus is unaware of the existence of the critic 52.

The assistant 48 is configured to review the error report and solutions, perform a correction, and recommend additional tool calls to the user proxy 50. The first conversation 62 and the second conversation 66 comprise the tool call and analysis loop 56, which repeats until the critic 52 determines that the tool response report is free of errors. Returning briefly to FIG. 1, when the tool response report is determined to be accurate, the user proxy 50 may generate an alert report 70 that is output by the alert investigation agent 46 and received downstream of the SOC investigation program 26 by an alert response agent 72.

As the assistant 48 and the user proxy 50 are implemented utilizing LLMs, there are limitations to consider, such as the size of the context windows. Factors that impact the context window include the system prompt and tool definitions. System prompts must be precise and focused on a constrained problem area without being too open-ended. Tool definitions are forwarded to the assistant 48 and the user proxy 50 at every turn in the first conversation 62 and consume parts of their respective context windows, thereby restricting the number of tools that can be effectively used in agentic tool flow. Additionally, receiving a large amount of text increases the possibility of the assistant 48 and the user proxy 50 generating hallucinations and/or errors. Tools provided to the investigation agent 46 are simple functions that take input and return output, with their internal implementation details being irrelevant to the assistant 48 or the user proxy 50. As such, the assistant 48 may recommend another investigation agent as a tool to delegate subproblems and limit the amount of text in the context windows.

FIG. 2B shows a schematic illustration of an agent call and analysis loop 56A. In a first conversation 62A (i.e., agentic agent flow, indicated by the dash-dot-dot line), the alert investigation agent 46 is a first-level agent 46A, and the user proxy 50 receives a recommendation for a second-level investigation agent 46B, as indicated at (2A). The user proxy 50 executes the second-level agent 46B (3A), and receives an agent response (4A). As in the first conversation 62, the agent response is returned to the assistant 48 (5A), which generates an agent response report that is returned to the user proxy 50 (6A). The user proxy 50 sends the agent response report to the critic 52 (7A), thereby initiating a second conversation 66A in which the critic 52 reviews the agent response report for errors and generates and error report that is sent to the user proxy 50 (8) and forwarded to the assistant 48 (9).

In some implementations, the alert investigation agent 46 may call multiple second-level agents 46B to investigate certain aspects of the alert event, and the second-level agents 46B may in turn call one or more third-level agents 46C as tools. The multi-agent architecture with agent tools provides an agentic workflow in which different types of evidence in the alert message can be examined individually by specialized investigation agents without overwhelming the system or increasing the risk of hallucinations and/or errors.

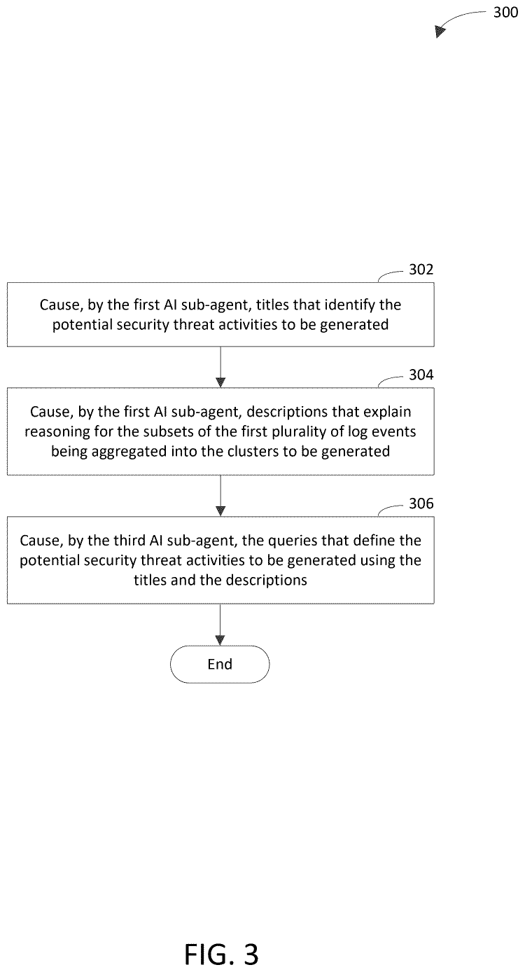

Turning to FIG. 3, a schematic view of a multi-agent orchestration with agent tools is shown. In the illustrated embodiment, the SOC investigation program 26 includes a plurality of AI-automated investigation agents, and the alert investigation agent 46 is one of the plurality of investigation agents in an agentic workflow. Each investigation agent has a respective assistant 48, a respective user proxy 50, and a respective critic 52. As described in detail above with reference to FIG. 1, the alert investigation agent 46 is configured as a first-level agent 46A and receives the alert message 44 that triggers the alert prompt 54.

The first-level agent 46A implements a first-level agentic flow, i.e., tool call and analysis loop, 56A to determine one or more second-level agents 46B to call as a tool for investigating the alert event. For example, as shown in FIG. 3, the alert message 44 may reference an Indicator of Compromise (IOC), such as an email 44A, that includes additional IOCs like an Internet Protocol (IP) address 44B1, a Uniform Resource Locator (URL) 44B2, and a file attachment 44B3, relevant downstream agents can be called as tools to individually investigate each IOC. The second-level agents 46B may include a domain investigation agent 46B1, an email investigation agent 46B2, a file investigation agent 46B3, an IP investigation agent 46B4, a URL investigation agent 46B5, and a user investigation agent 46B6, for example.

Each of the second-level agents 46B includes a respective system prompt and tool definitions, and is configured to receive a second-level prompt 54B from the first-level agent 46A to trigger a tool call and analysis loop 56, which may be implemented as a second-level agentic flow, to investigate the relevant IOC. Each of the second-level agentic flows comprises a respective first conversation 62 between the assistant 48 and the user proxy 50 and a respective second conversation 66 between the user proxy 50 and the critic 52, as described in detail above with reference to FIGS. 2A and 2B. When the respective agent response report is determined to be error-free, it is returned to the first-level alert investigation agent 46A.

One or more of the second-level agents 46B may call one or more third-level agents as tools. In the example shown in FIG. 3, the second-level email investigation agent 46B2 calls a third-level file investigation agent 46C1 and a third-level URL investigation agent 46C2. The third-level URL investigation agent 46C2 may additionally call a fourth-level investigation agent 46D, such as a web page image investigation agent 46D.

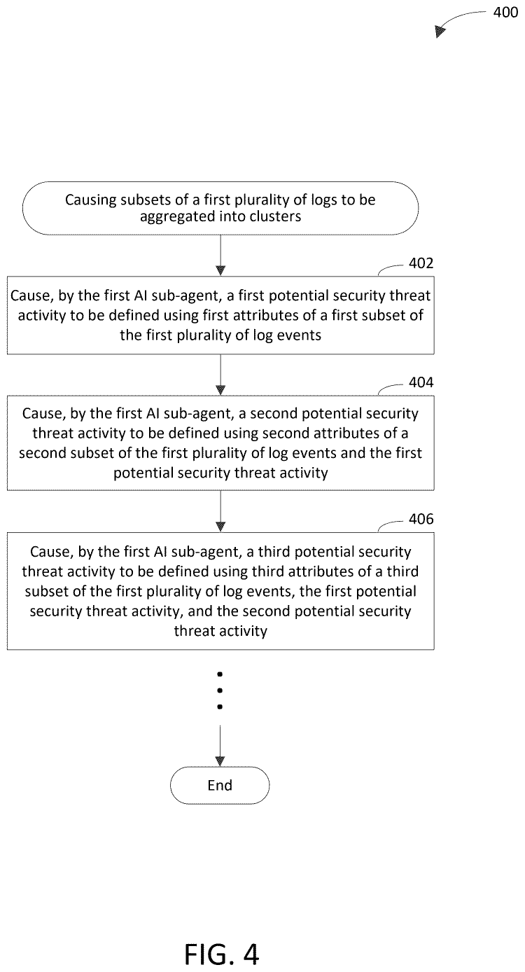

FIG. 4 shows a flowchart for a method 400 for artificial intelligence-automated review of agentic flows. Method 400 may be implemented by the hardware and software of computing system 10 described above, or by other suitable hardware and software. At step 402, the method 400 may include receiving, at a user proxy included in an automated artificial intelligence (AI) agent, an event prompt, the event prompt including information related to an event and instructions to investigate the event. As described in detail above, the event may be a security alert event, and an alert investigation agent in an SOC investigation program may receive alert information that triggers an agentic flow to investigate the event.

Steps 404 to 410 occur in a first conversation between the user proxy and an assistant included in the agent. As described above, the user proxy and the assistant may be implemented utilizing LLMs. Proceeding from step 402 to step 404, at step 404 the method 400 may further include receiving, at the user proxy, a recommendation for a tool from the assistant. Advancing from step 404 to step 406, at step 406 the method 400 may further include returning, at the user proxy, a tool response to the assistant after executing the recommended tool. Continuing from step 406 to step 408, at step 408 the method 400 may further include generating, at the assistant, a tool response report. Proceeding from step 408 to step 410, at step 410 the method 400 may further include sending, at the assistant, the tool response report to the user proxy

Steps 412 to 416 occur in a second conversation between the user proxy and a critic included in the agent. Advancing from step 410 to step 412, at step 412 the method 400 may further include sending, at the user proxy, the tool response report to the critic. As described above, the critic may be implemented using an LLM invoked by the user proxy, or it may be embedded in the user proxy.

Continuing from step 412 to step 414, at step 414 the method 400 may further include reviewing, at the critic, the tool response report for errors, and detecting one or more errors in the tool response report. Proceeding from step 414 to step 416, at step 416 in the case that one or more errors is detected by the critic, the method 400 may further include returning, at the critic, any of the one or more detected errors to the user proxy. As described above, the method may further include suggesting, at the critic, one or more solutions to the user proxy to repair the one or more detected errors.

Advancing from step 416 to step 418, at step 418 the method 400 may further include relaying, at the user proxy, the detected errors to the assistant. The suggested solutions from the critic may additionally be relayed to the assistant by the user proxy. As described above, the user proxy relays the error report to the assistant as though it were its own conclusion. Thus, the assistant is naïve to the second conversation between the user proxy and the critic.

The first conversation and the second conversation comprise a tool call and analysis loop, and the method may further include repeating the tool call and analysis loop until the critic determines that the first conversation is free of errors.

In some embodiments, the agent is a first-level agent, and the method further comprises recommending, at the assistant, a second-level agent as a tool to process the event.

In some embodiments, the agent is one of a plurality of investigation agents, and the method further includes implementing a security operations center (SOC) investigation program that includes the plurality of investigation agents.

In some embodiments, the methods and processes described herein may be tied to a computing system of one or more computing devices. In particular, such methods and processes may be implemented as a computer-application program or service, an application-programming interface (API), a library, and/or other computer-program product.

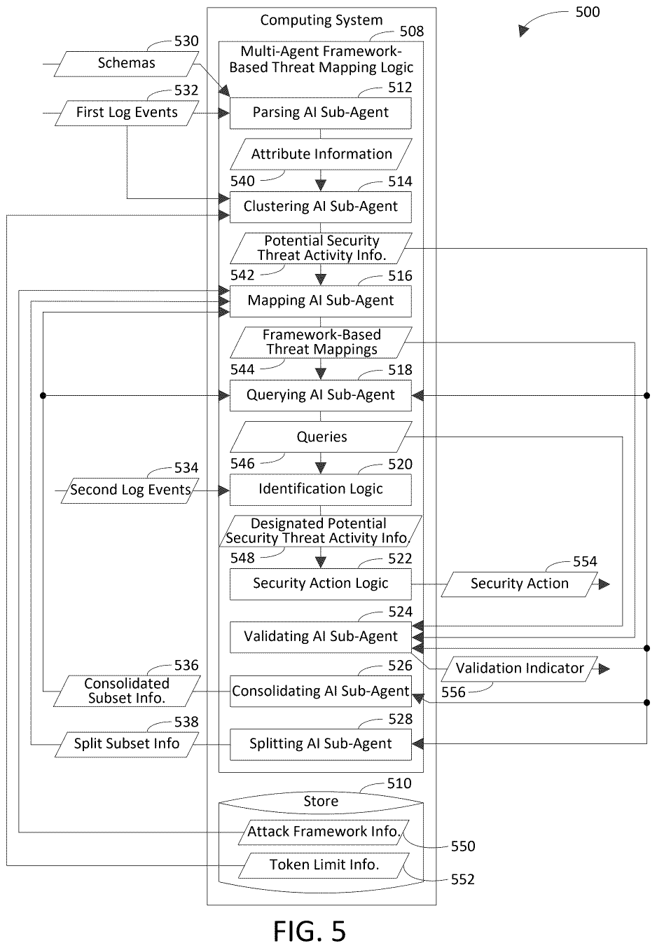

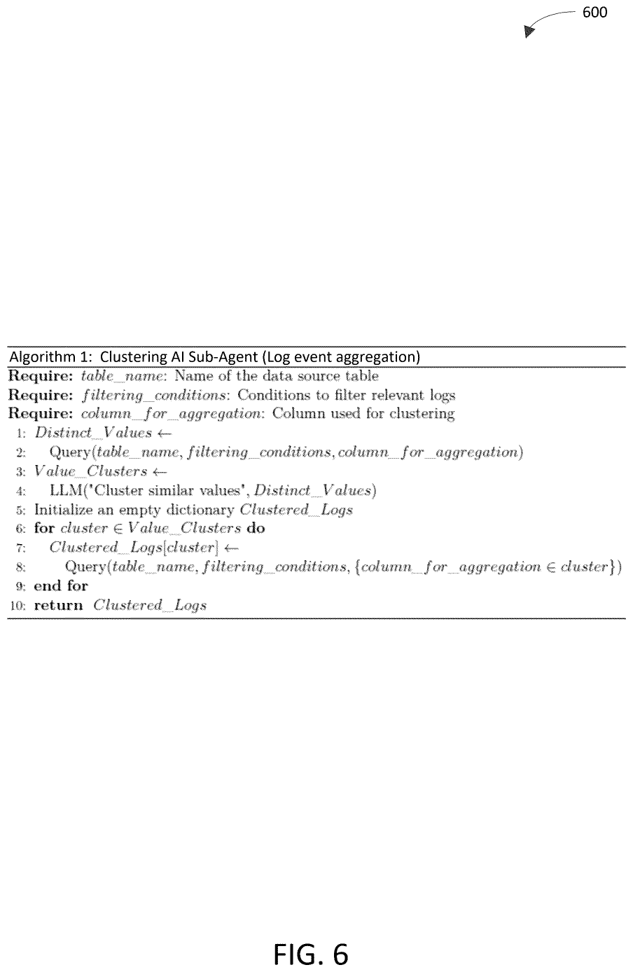

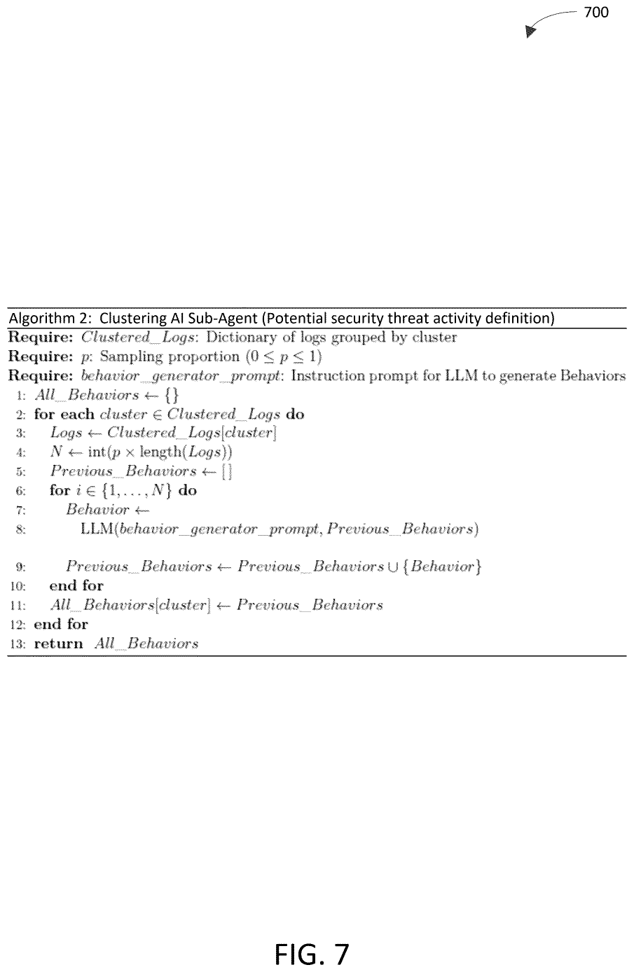

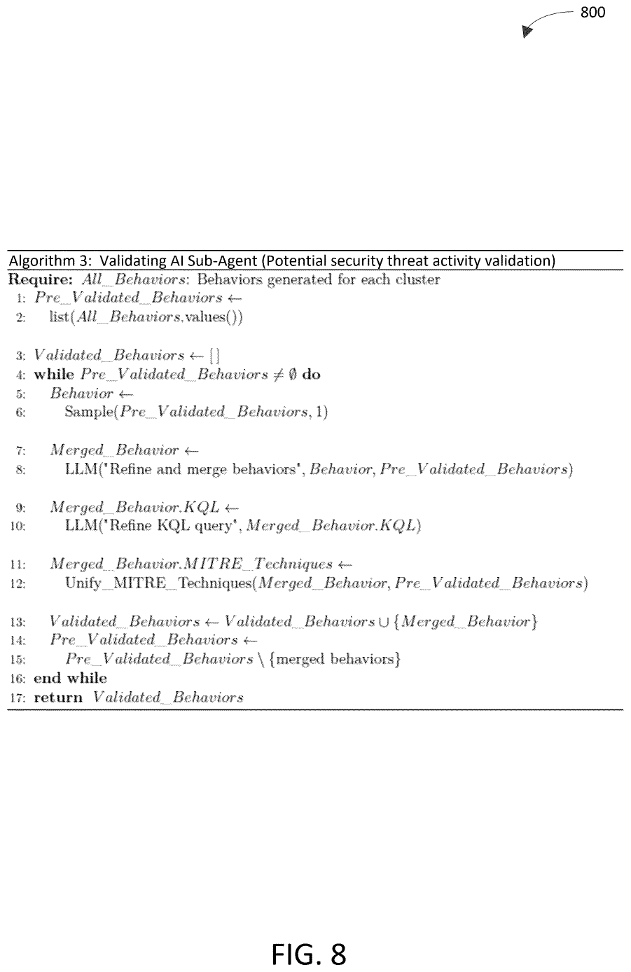

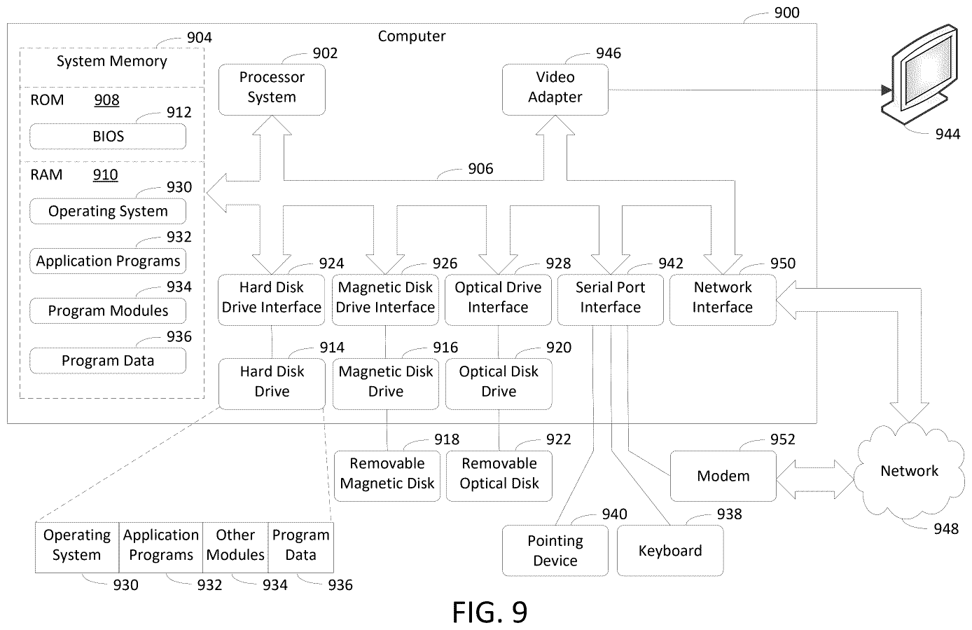

FIG. 5 schematically shows a non-limiting embodiment of a computing system 500 that can enact one or more of the methods and processes described above. Computing system 500 is shown in simplified form. Computing system 500 may embody the computing system 1 described above and illustrated in FIG. 1. Components of computing system 500 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 500 includes a logic processor 502 volatile memory 504, and a non-volatile storage device 506. Computing system 500 may optionally include a display subsystem 508, input subsystem 510, communication subsystem 512, and/or other components not shown in FIG. 5.

Logic processor 502 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the logic processor 502 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 506 includes one or more physical devices configured to hold instructions executable by the logic processors to implement the methods and processes described herein. When such methods and processes are implemented, the state of non-volatile storage device 506 may be transformed—e.g., to hold different data.

Non-volatile storage device 506 may include physical devices that are removable and/or built in. Non-volatile storage device 506 may include optical memory, semiconductor memory, and/or magnetic memory, or other mass storage device technology. Non-volatile storage device 506 may include nonvolatile, dynamic, static, read/write, read-only, sequential-access, location-addressable, file-addressable, and/or content-addressable devices. It will be appreciated that non-volatile storage device 506 is configured to hold instructions even when power is cut to the non-volatile storage device 506.

Volatile memory 504 may include physical devices that include random access memory. Volatile memory 504 is typically utilized by logic processor 502 to temporarily store information during processing of software instructions. It will be appreciated that volatile memory 504 typically does not continue to store instructions when power is cut to the volatile memory 504.

Aspects of logic processor 502, volatile memory 504, and non-volatile storage device 506 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 500 typically implemented in software by a processor to perform a particular function using portions of volatile memory, which function involves transformative processing that specially configures the processor to perform the function. Thus, a module, program, or engine may be instantiated via logic processor 502 executing instructions held by non-volatile storage device 506, using portions of volatile memory 504. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 508 may be used to present a visual representation of data held by non-volatile storage device 506. The visual representation may take the form of a graphical user interface (GUI). As the herein described methods and processes change the data held by the non-volatile storage device, and thus transform the state of the non-volatile storage device, the state of display subsystem 508 may likewise be transformed to visually represent changes in the underlying data. Display subsystem 508 may include one or more display devices utilizing virtually any type of technology. Such display devices may be combined with logic processor 502, volatile memory 504, and/or non-volatile storage device 506 in a shared enclosure, or such display devices may be peripheral display devices.

When included, input subsystem 510 may comprise or interface with one or more user-input devices such as a keyboard, mouse, touch screen, camera, or microphone.

When included, communication subsystem 512 may be configured to communicatively couple various computing devices described herein with each other, and with other devices. Communication subsystem 512 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 500 to send and/or receive messages to and/or from other devices via a network such as the Internet.

The following paragraphs provide additional support for the claims of the subject application. One aspect provides a computing system for artificial intelligence-automated review of agentic flows. The computing system for artificial intelligence-automated review of agentic flows comprises a computing device. The computing device includes processing circuitry configured to execute instructions using portions of associated memory to implement an agentic flow in an automated artificial intelligence (AI) agent. The agent comprises an assistant, a user proxy, and a critic. The user proxy is configured to receive information related to an event and implement an agentic flow to determine one or more tools to process the event. In a first conversation between the assistant and the user proxy, the user proxy receives a recommendation for a tool from the assistant and returns a tool response to the assistant after executing the recommended tool. The assistant generates a tool response report and sends the tool response report to the user proxy. In a second conversation between the user proxy and the critic, the user proxy sends the tool response report to the critic, and the critic reviews the tool response report for errors. In a case that one or more errors is detected by the critic, the critic returns the one or more detected errors to the user proxy, and the user proxy relays the one or more detected errors to the assistant.

In this aspect, additionally or alternatively, the assistant is naïve to the second conversation between the user proxy and the critic.

In this aspect, additionally or alternatively, the critic is further configured to suggest solutions to the user proxy to repair the detected errors, and the user proxy relays the suggested solutions to the assistant.

In this aspect, additionally or alternatively, the first conversation and the second conversation comprise a tool call and analysis loop, and the tool call and analysis loop repeats until the critic determines that the first conversation is free of errors.

In this aspect, additionally or alternatively, the agent is a first-level agent, and the assistant recommends a second-level agent as a tool to process the event.

In this aspect, additionally or alternatively, the critic is invoked by the user proxy.

In this aspect, additionally or alternatively, the critic is embedded in the user proxy.

In this aspect, additionally or alternatively, the assistant, the user proxy, and the critic are implemented as large language models.

In this aspect, additionally or alternatively, the agent is one of a plurality of investigation agents included in an agentic workflow, and the processing circuitry is configured to implement a security operations center (SOC) investigation program that comprises the plurality of investigation agents.

Another aspect provides a method for artificial intelligence-automated review of agentic flows. The method comprises receiving, at a user proxy included in an automated artificial intelligence (AI) agent, an event prompt. The event prompt includes information related to an event and instructions to process the event. In a first conversation between the user proxy and an assistant included in the agent, the method comprises receiving, at the user proxy, a recommendation for a tool from the assistant; returning, at the user proxy, a tool response to the assistant after executing the recommended tool; generating, at the assistant, a tool response report; and sending, at the assistant, the tool response report to the user proxy. In a second conversation between the user proxy and a critic included in the agent, the method comprises sending, at the user proxy, the tool response report to the critic, and reviewing, at the critic, the tool response report for errors. In a case that one or more errors is detected by the critic, the method includes returning, at the critic, the one or more detected errors to the user proxy, and relaying, at the user proxy, the one or more detected errors to the assistant

In this aspect, additionally or alternatively, the assistant is naïve to the second conversation between the user proxy and the critic.

In this aspect, additionally or alternatively, the method may further comprise suggesting, at the critic, one or more solutions to the user proxy to repair the detected errors, and relaying, at the user proxy, the suggested one or more solutions to the assistant.

In this aspect, additionally or alternatively, the first conversation and the second conversation comprise a tool call and analysis loop, and the method further comprises repeating the tool call and analysis loop until the critic determines that the first conversation is free of errors.

In this aspect, additionally or alternatively, the agent is a first-level agent, and the method further comprises recommending, at the assistant, a second-level agent as a tool to process the event.

In this aspect, additionally or alternatively, the method may further comprise invoking, at the user proxy, the critic.

In this aspect, additionally or alternatively, the method may further comprise embedding the critic in the user proxy.

In this aspect, additionally or alternatively, the method may further comprise implementing the assistant, the user proxy, and the critic as large language models.

In this aspect, additionally or alternatively, the agent is one of a plurality of investigation agents included in an agentic workflow, and the method further includes implementing a security operations center (SOC) investigation program, the SOC investigation program comprising the plurality of investigation agents.

Another aspect provides a computing system for artificial intelligence-automated review of agentic flows. The computing system comprises a computing device including processing circuitry configured to execute instructions using portions of associated memory to implement a security operations center (SOC) investigation program. The SOC investigation program includes a plurality of artificial intelligence (AI)-automated investigation agents in an agentic workflow. Each agent of the plurality of agents has a respective assistant, a respective user proxy, and a respective critic. A first-level agent of the plurality of agents is configured to receive information related to an alert event and implement a first-level agentic flow to determine one or more second-level agents of the plurality of agents to investigate the alert event. Each of the one or more second-level agents is configured to receive a respective second-level prompt from the first-level agent and implement a respective second-level agentic flow. Each of the first- and second-level agentic flows comprises a respective first conversation between the assistant and the user proxy in which the user proxy receives a recommendation for a tool from the assistant and returns a tool response to the assistant after executing the recommended tool, and the assistant generates a tool response report and sends the tool response report to the user proxy. In a respective second conversation between the user proxy and the critic, the user proxy sends the tool response report to the critic, and the critic reviews the tool response report for errors. In a case that one or more errors is detected by the critic, the critic returns the one or more detected errors to the user proxy, and the user proxy relays the one or more detected errors to the assistant.

In this aspect, additionally or alternatively, the assistant is naïve to the respective second conversation.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for artificial intelligence-automated review of agentic flows, comprising:
a computing device including processing circuitry configured to execute instructions using portions of associated memory to implement an agentic flow in an automated artificial intelligence (AI) agent, the agent comprising an assistant, a user proxy, and a critic, wherein
the user proxy is configured to receive information related to an event and implement an agentic flow to determine one or more tools to process the event,
in a first conversation between the assistant and the user proxy, the user proxy receives a recommendation for a tool from the assistant and returns a tool response to the assistant after executing the recommended tool, and the assistant generates a tool response report and sends the tool response report to the user proxy,
in a second conversation between the user proxy and the critic, the user proxy sends the tool response report to the critic, the critic reviews the tool response report for errors, and, in a case that one or more errors is detected by the critic, the critic returns the one or more detected errors to the user proxy, and
the user proxy relays the one or more detected errors to the assistant.

2. The computing system of claim 1, wherein
the assistant is naïve to the second conversation between the user proxy and the critic.

3. The computing system of claim 1, wherein
the critic is further configured to suggest solutions to the user proxy to repair the detected errors, and
the user proxy relays the suggested solutions to the assistant.

4. The computing system of claim 1, wherein
the first conversation and the second conversation comprise a tool call and analysis loop, and
the tool call and analysis loop repeats until the critic determines that the first conversation is free of errors.

5. The computing system of claim 1, wherein
the agent is a first-level agent, and
the assistant recommends a second-level agent as a tool to process the event.

6. The computing system of claim 1, wherein
the critic is invoked by the user proxy.

7. The computing system of claim 1, wherein
the critic is embedded in the user proxy.

8. The computing system of claim 1, wherein
the assistant, the user proxy, and the critic are implemented as large language models.

9. The computing system of claim 1, wherein
the agent is one of a plurality of investigation agents included in an agentic workflow, and
the processing circuitry is configured to implement a security operations center (SOC) investigation program, the SOC investigation program comprising the plurality of investigation agents.

10. A method for artificial intelligence-automated review of agentic flows, comprising:
receiving, at a user proxy included in an automated artificial intelligence (AI) agent, an event prompt, the event prompt including information related to an event and instructions to process the event;
in a first conversation between the user proxy and an assistant included in the agent:
receiving, at the user proxy, a recommendation for a tool from the assistant;
returning, at the user proxy, a tool response to the assistant after executing the recommended tool;
generating, at the assistant, a tool response report;
sending, at the assistant, the tool response report to the user proxy;
in a second conversation between the user proxy and a critic included in the agent:
sending, at the user proxy, the tool response report to the critic;
reviewing, at the critic, the tool response report for errors;
in a case that one or more errors is detected by the critic, returning, at the critic, the one or more detected errors to the user proxy; and
relaying, at the user proxy, the one or more detected errors to the assistant.

11. The method of claim 10, wherein
the assistant is naïve to the second conversation between the user proxy and the critic.

12. The method of claim 10, the method further comprising:
suggesting, at the critic, one or more solutions to the user proxy to repair the detected errors, and
relaying, at the user proxy, the suggested one or more solutions to the assistant.

13. The method of claim 10, wherein
the first conversation and the second conversation comprise a tool call and analysis loop, and
the method further comprises repeating the tool call and analysis loop until the critic determines that the first conversation is free of errors.

14. The method of claim 10, wherein
the agent is a first-level agent, and
the method further comprises recommending, at the assistant, a second-level agent as a tool to process the event.

15. The method of claim 10, the method further comprising:
invoking, at the user proxy, the critic.

16. The method of claim 10, the method further comprising:
embedding the critic in the user proxy.

17. The method of claim 10, the method further comprising:
implementing the assistant, the user proxy, and the critic as large language models.

18. The method of claim 10, wherein
the agent is one of a plurality of investigation agents included in an agentic workflow, and
the method further includes implementing a security operations center (SOC) investigation program, the SOC investigation program comprising the plurality of investigation agents.

19. A computing system for artificial intelligence-automated review of agentic flows, comprising:
a computing device including processing circuitry configured to execute instructions using portions of associated memory to implement a security operations center (SOC) investigation program, the SOC investigation program including a plurality of artificial intelligence (AI)-automated investigation agents in an agentic workflow, each agent of the plurality of agents having a respective assistant, a respective user proxy, and a respective critic, wherein
a first-level agent of the plurality of agents is configured to receive information related to an alert event and implement a first-level agentic flow to determine one or more second-level agents of the plurality of agents to investigate the alert event,
each of the one or more second-level agents is configured to receive a respective second-level prompt from the first-level agent and implement a respective second-level agentic flow,
each of the first- and second-level agentic flows comprises a respective first conversation between the assistant and the user proxy in which the user proxy receives a recommendation for a tool from the assistant and returns a tool response to the assistant after executing the recommended tool, and the assistant generates a tool response report and sends the tool response report to the user proxy,
in a respective second conversation between the user proxy and the critic, the user proxy sends the tool response report to the critic, the critic reviews the tool response report for errors, and, in a case that one or more errors is detected by the critic, the critic returns the one or more detected errors to the user proxy, and
the user proxy relays the one or more detected errors to the assistant.

20. The computing system of claim 19, wherein
the assistant is naïve to the respective second conversation.
